(19) United States
(12) Patent Application Publication
(10) Pub. No.: US 2003/0189341 A1
(43) Pub. Date: Oct. 9, 2003

(54) Door jamb extension apparatus

(76) Inventor: Brian C. Perry, Newark, DE (US)

Correspondence Address: S. Michael Bender, P.O. Box 530399, St. Petersburg, FL, 33747, US

(21) Appl. No.: 10/118,173

(22) Filed: Apr. 8, 2002

(51) Int. Cl. E05B 17/00

(52) U.S. Cl. 292/346

(57) ABSTRACT

A door jamb extension apparatus is provided for filling a gap between a door-mounted box and a door jamb and includes an inner or first wall portion, an intermediate wall portion connected to the inner wall portion, and an outer or second wall portion connected to the intermediate wall portion. The inner wall portion and the outer wall portion are mounted on a portion of the door jamb, and the inner wall portion and the outer wall portion fill the gap between the door-mounted box and the door jamb. By filling the gap between the door-mounted box and the door jamb, a spreader bar cannot be used to damage the door-mounted box. Preferably, the door jamb includes a door jamb lip, and the inner wall portion and the outer wall portion are mounted on the door jamb lip.

### BACKGROUND OF THE INVENTION

1. Field of the Invention

The present invention relates generally to devices intended to prevent illegal entry into a room, and, more particularly, to a device especially adapted for placement between an electronic card entry box and a door jamb.

2. Description of the Prior Art

As shown in the prior art FIG. 1, a gap 21 conventionally exists between an electronic card entry box 17, which receives a magnetic entry card, and a door jamb 11, on many hotel doors 15. U.S. Pat. No. 5,707,090 discloses such a magnetic-card-operated door lock. Unfortunately, criminals have used spreader bars in the gap 21 between the electronic card entry box 17 and the door jamb 11 to break the integrity of the electronic card entry box 17 and its associated door lock mechanism and to break into a hotel room. Such a gap is also shown in U.S. Pat. No. 5,707,090. In this respect, there is a need to prevent the use of spreader bars to alter the integrity of electronic card entry boxes and their door lock assemblies in order to gain illegal entry into hotel rooms.

Because there are great numbers of electronic card entry boxes existing on doors, there is a need to retrofit conventional doors and door jambs to prevent the use of spreader bars wedged between the electronic card entry boxes and the door jamb to gain entry into hotel rooms.

For purposes of simplicity and economy, it would be desirable to retrofit existing doors and door jambs with a minimal amount of damage to the existing doors and door jambs and with little or no adverse impact upon the aesthetic appearance of the hotel door involved.

Aside from the use of magnetic card operated electronic card entry boxes on hotel doors for controlling door locks, other types of locks are conventionally used on doors. For example, as shown in U.S. Pat. No. 4,633,687, a key-operated lock is employed on a door, and a gap is also present between the key-operated lock and a door jamb. In this respect, it would also be desirable to retrofit such existing doors and door jambs to prevent use of spreader bars for damaging key-operated locks or the adjacent door jamb sufficiently to defeat their purpose as secure locking devices.

The prior art described above does not teach or suggest a door jamb extension apparatus which has the following combination of desirable features: (1) prevents the use of spreader bars to defeat the lock on electronic card entry boxes for gaining illegal entry into hotel rooms; (2) permits retrofitting conventional doors and door jambs to prevent the use of spreader bars or other devices to be wedged between electronic card entry boxes and the adjacent door jamb in order to gain unauthorized entry into hotel rooms; (3) permits retrofitting existing doors and door jambs with a minimal amount of damage to the existing doors and door jambs; (4) permits retrofitting existing doors and door jambs to avoid the unauthorized use of wedging tools between the electronic lock box on the door and the adjacent door jamb without adversely affecting the aesthetic appearance of the door and door jamb; and (5) permits retrofitting existing doors and door jambs to prevent use of spreader bars or similar tools for damaging key-operated locks. The foregoing desired characteristics are provided by the unique door jamb extension apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a door jamb extension apparatus for filling a gap between a door-mounted box and a door jamb and includes an inner or first wall portion, an intermediate wall portion connected to the inner wall portion, and an outer or second wall portion connected to the intermediate wall portion. The inner wall portion and the outer wall portion are mounted on a portion of the door jamb, and the inner wall portion and the outer wall portion fill the gap between the door-mounted box and the door jamb. By filling the gap between the door-mounted box and the door jamb, a spreader bar cannot be used to damage the door-mounted box.

Preferably, the door jamb includes a door jamb lip, and the inner wall portion and the outer wall portion are mounted on the door jamb lip. Preferably, the inner wall portion includes fastener-reception channels. Preferably, the inner wall portion and the outer wall portion are planar and are parallel to each other. Preferably, the intermediate wall portion is planar and is perpendicular to the inner wall portion and the outer wall portion. The intermediate wall portion provides separation of the inner wall portion from the outer wall portion by a wall-to-wall gap.

Preferably, the inner wall portion, the intermediate wall portion, and the outer wall portion are formed as a unified structure. The inner wall portion and the outer wall portion have a wall width, the gap has a gap width, and the inner wall portion and the outer wall portion substantially fill the gap width.

In accordance with another aspect of the invention, a method of filling a gap on a door between a door-mounted box and a door jamb includes the step of attaching a door jamb extension apparatus to the door jamb so that the door jamb extension apparatus substantially fills the gap between the door-mounted box and the doorjamb.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved door jamb extension apparatus which has all of the advantages of the prior art and none of the disadvantages.

It is another object of the present invention to provide a new and improved door jamb extension apparatus which may be easily and efficiently manufactured and marketed.

It is a further object of the present invention to provide a new and improved door jamb extension apparatus which is of durable and reliable construction.

An even further object of the present invention is to provide a new and improved door jamb extension apparatus which is susceptible of a low cost of manufacture with regard to both materials and labor, and which accordingly is then susceptible of low prices of sale to the consuming public, thereby making such door jamb extension apparatus available to the buying public.

Still yet a further object of the present invention is to provide a new and improved door jamb extension apparatus which prevents the use of spreader bars to break electronic card entry boxes for gaining illegal entry into hotel rooms.

Still another object of the present invention is to provide a new and improved door jamb extension apparatus that permits retrofitting conventional doors and door jambs to prevent the unauthorized use of spreader bars or other tools to break electronic card entry boxes or the adjacent door jamb to gain entry into hotel rooms.

Yet another object of the present invention is to provide a new and improved door jamb extension apparatus which permits retrofitting existing doors and door jambs with a minimal amount of damage to the existing doors and door jambs.

It is still yet another object of the present invention to avoid the unauthorized use of wedging tools or other break-in devices between the electronic lock box on the door and the adjacent door jamb without adversely affecting the aesthetic appearance of the associated door and door jamb.

Even another object of the present invention is to provide a new and improved door jamb extension apparatus that permits retrofitting existing doors and door jambs to prevent use of spreader bars or similar tools for damaging key-operated locks.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front view showing the PRIOR ART of a door having an electronic card entry box which is spaced away from a door jamb by a gap.

FIG. 2 is a front view of an embodiment of the door jamb extension apparatus of the invention installed a door jamb and filling the gap between the electronic card entry box on the door and the door jamb.

FIG. 3 is a cross-sectional view of the embodiment of the door jamb extension apparatus of FIG. 2 taken along line 3-3 thereof.

FIG. 4 is an inside view of the embodiment of the door jamb extension apparatus of FIG. 3 taken along line 4-4 thereof.

FIG. 5 is an exploded perspective view of an installation of the door jamb extension apparatus of the invention, shown in FIGS. 2-4, and its relationship to a door jamb lip of a door jamb and fasteners.

### DESCRIPTION OF THE PREFERRED EMBODIMENT

With reference to the drawings, a new and improved door jamb extension apparatus embodying the principles and concepts of the present invention will be described.

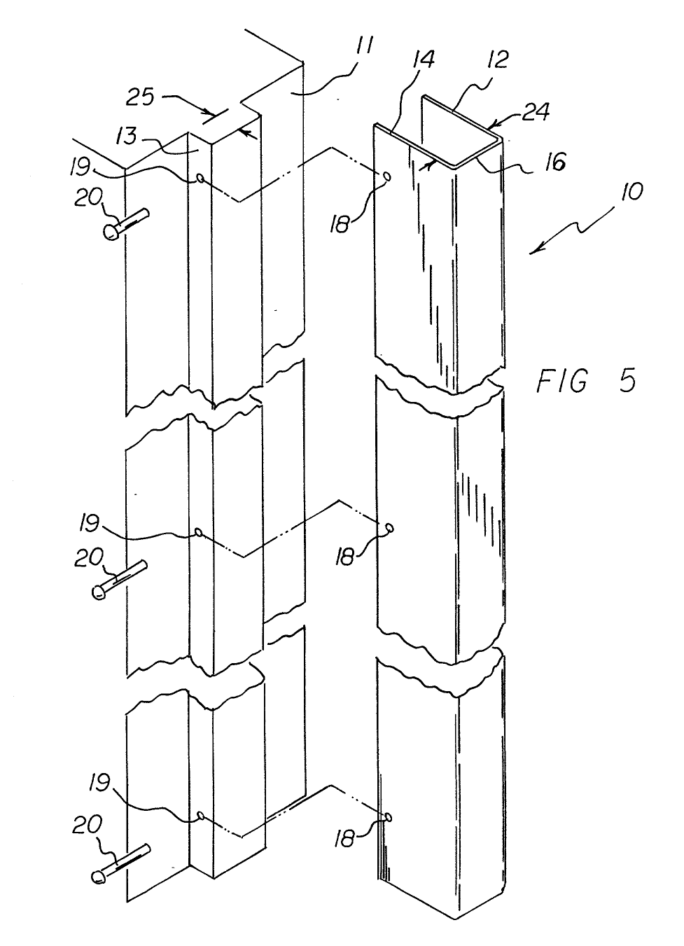

Turning to FIGS. 1-5, there is shown an exemplary embodiment of the door jamb extension apparatus of the invention generally designated by reference numeral 10. In its preferred form, a door jamb extension apparatus 10 is provided for filling a gap 21 between a door-mounted box and a door jamb 11 and includes an inner or first wall portion 14, an intermediate wall portion 16 connected to the inner wall portion 14, and an outer or second wall portion 12 connected to the intermediate wall portion 16. The inner wall portion 14 and the outer wall portion 12 are mounted on a portion of the door jamb 11, and the inner wall portion 14 and the outer wall portion 12 fill the gap 21 between the door-mounted box and the door jamb 11.

Preferably, the door jamb 11 includes a door jamb lip 13, and the inner wall portion 14 and the outer wall portion 12 are mounted on the door jamb lip 13. Preferably, the inner wall portion 14 includes fastener-reception channels 18. Preferably, the inner wall portion 14 and the outer wall portion 12 are planar and are parallel to each other. Preferably, the intermediate wall portion 16 is planar and is perpendicular to the inner wall portion 14 and the outer wall portion 12. The intermediate wall portion 16 provides separation of the inner wall portion 14 from the outer wall portion 12 by a wall-to-wall gap 24.

Preferably, the inner wall portion 14, the intermediate wall portion 16, and the outer wall portion 12 are formed as a unified structure. The inner wall portion 14 and the outer wall portion 12 have a wall width 28, the gap 21 has a gap width, and the inner wall portion 14 and the outer wall portion 12 substantially fill the gap width.

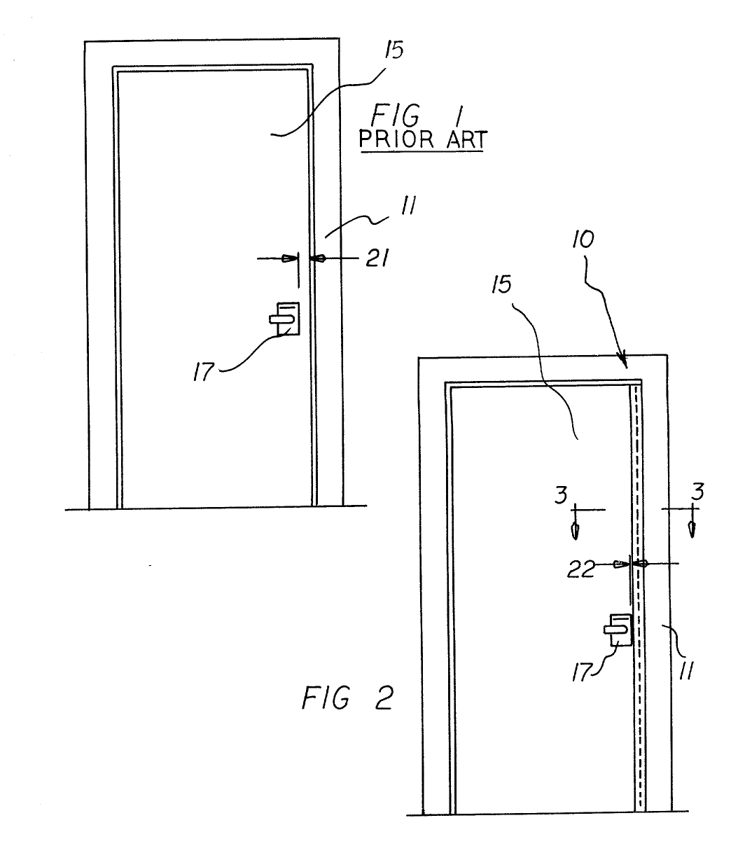

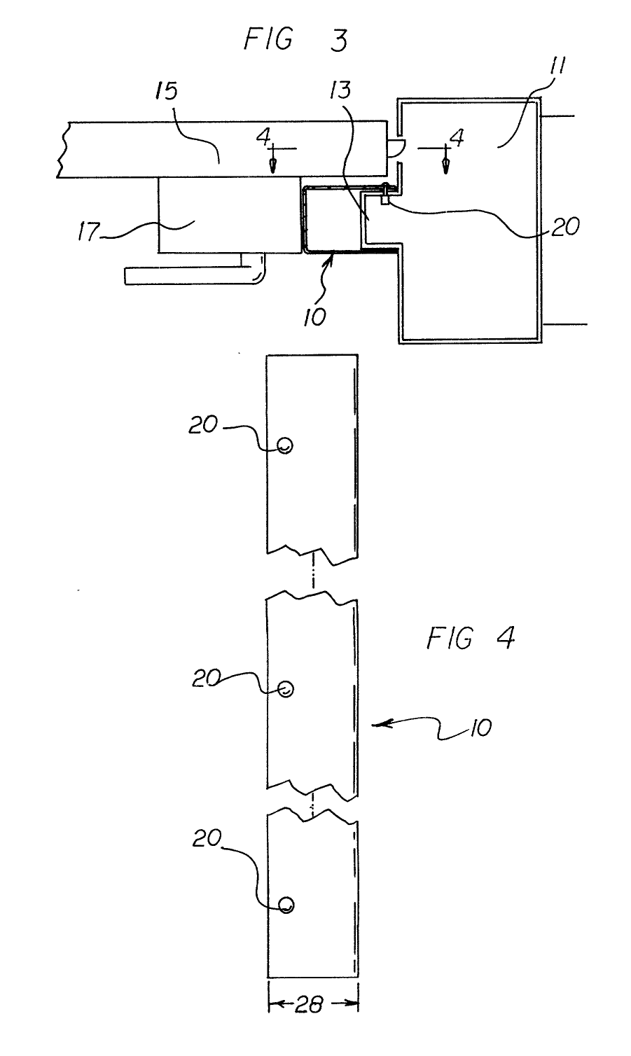

To install the door jamb extension apparatus 10 of the invention on a door jamb lip 13, part of the inner wall portion 14 is placed over the inner wall of the door jamb lip 13, whereas part of the outer wall portion 12 is placed over the outer wall of the door jamb lip 13 substantially as illustrated in 2 and 3. While it is possible to press-fit the door jamb extension apparatus 10 in place onto lip 13 of jamb 11, one or more fasteners 20 are preferably used to securely join the door jamb extension apparatus 10 directly to the door jamb 11. Thus, as shown in FIGS. 3-5, fasteners 20 may be installed through the fastener-reception channels 18 suitably formed in portion 14 of the door jamb extension apparatus 10 and into the door jamb lip 13. The fasteners 20, when installed in the door jamb lip 13, make fastener-reception channels 19 in the door jamb lip 13. Alternatively, fastener-reception channels 19 can be drilled in the door jamb lip 13 prior to installation. When this is done, the door 15 can be opened and closed in the normal way, and the door jamb extension apparatus 10 fills the gap 21 between the door-mounted box, such as an electronic card entry box 17, and the door jamb 11. After the door jamb extension apparatus 10 is installed on the door jamb 11, a small clearance gap 22 is present between the electronic card entry box 17 and the door jamb extension apparatus 10. This small clearance gap 22 is too small to permit use of a spreader bar or other tool (not shown) to be wedged between the box 17 and the jamb 11 to facilitate illegal or unauthorized entry to a room. Also, it will be noted that when the fasteners 20 are installed on the rear facing side of door jamb lip 13, the fasteners are normally hidden from view when observing the front of the door as viewed in FIG. 2. This enhances the aesthetic appearance of the installed door jamb extension apparatus 10.

Dimensions of the door jamb extension apparatus 10 can vary depending upon specific dimensions of a gap 21 between a door-mounted box and a door jamb 11 and specific dimensions of a door jamb lip 13. However, for a typical common retrofitting application, and merely as illustrative of the present invention, the following preferred dimensions may be utilized. In this respect, the wall width 28 can be 1.5 inches. The wall-to-wall gap 24 can be 2.063 inches. The door jamb lip 13 can have a door jamb lip height 25 of 0.625 inches. The door jamb lip 13 can be hollow, or it can be solid throughout.

When used in a typical retrofitted installation, the door jamb extension apparatus 10 is preferably color matched to the existing door jamb (as by using the same paint color, for example). Additionally, its longitudinal extent or length preferably is selected such that it will extend upright substantially along the entire longitudinal extent of the door jamb 11 adjacent the electronic door-mounted box (i.e. substantially as shown in FIG. 2). In this manner, the installed door jamb extension apparatus 10 will have little or no impact upon the aesthetic appearance of the respective door.

The fasteners 20 can be embodied in a number of ways, including nails and screws. For a particular application the fasteners 20 are preferably BSS 44 steel pop rivets supplied by Lilly Fasteners. The unified structure of the inner wall portion 14, the intermediate wall portion 16, and the outer wall portion 12 can be made from 16 gauge galvanized and annealed steel, such as supplied by Ryerson Tull Company.

In accordance with another aspect of the invention, a method of filling a gap on a door between a door-mounted box and a door jamb includes the step of attaching a door jamb extension apparatus 10 according to the invention to the door jamb 11 so that the door jamb extension apparatus 10 substantially fills the gap between the door-mounted box and the door jamb 11 sufficiently to prevent unauthorized use of wedging tools or similar devices between the door-mounted box and the adjacent door jamb.

The components of the door jamb extension apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved door jamb extension apparatus that is low in cost, relatively simple in design and operation, and which may advantageously be used to prevent the use of spreader bars to interfere with the integrity of electronic card entry boxes for gaining illegal entry into hotel rooms. With the invention, a door jamb extension apparatus is provided which permits retrofitting conventional doors and door jambs to prevent the use of spreader bars to break electronic card entry boxes to gain unauthorized entry into hotel rooms. With the invention, a door jamb extension apparatus is provided which permits retrofitting existing doors and door jambs with a minimal amount of damage to the existing doors and door jambs. With the invention, a door jamb extension apparatus is provided which permits retrofitting existing doors and door jambs to avoid the unauthorized use of wedging tools between the electronic lock box on the door and the adjacent door jamb without adversely affecting the aesthetic appearance of the door and door jamb. With the invention, a door jamb extension apparatus is provided which permits retrofitting existing doors and door jambs to prevent unauthorized use of spreader bars or similar tools for damaging key-operated locks.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U. S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A door jamb extension apparatus for filling a gap between a door-mounted box and a door jamb, comprising:
a first wall portion,
an intermediate wall portion connected to said first wall portion, and
a second wall portion connected to said intermediate wall portion,
wherein said first wall portion and said second wall portion are mounted on a portion of the door jamb, and
wherein said first wall portion and said second wall portion fill the gap between the door-mounted box and the door jamb.

2. The apparatus of claim 1 wherein:
the door jamb includes a door jamb lip, and
said first wall portion and said second wall portion are mounted on the door jamb lip.

3. The apparatus of claim 1 wherein said first wall portion includes fastener-reception channels.

4. The apparatus of claim 1 wherein said first wall portion and second wall portion are planar and are parallel to each other.

5. The apparatus of claim 1 wherein said intermediate wall portion is planar and is perpendicular to said first wall portion and said second wall portion.

6. The apparatus of claim 1 wherein said intermediate wall portion provides separation of said first wall portion from said second wall portion by a wall-to-wall gap.

7. The apparatus of claim 1 wherein said first wall portion, said intermediate wall portion, and said second wall portion are formed as a unified structure.

8. The apparatus of claim 1 wherein:
said first wall portion and said second wall portion have a wall width,
the gap has a gap width, and
said first wall portion and said second wall portion substantially fill the gap width.

9. A method of filling a gap on a door between a door-mounted box and a door jamb, comprising the step of attaching a door jamb extension apparatus to the door jamb so that the door jamb extension apparatus substantially fills the gap between the door-mounted box and the door jamb.
